(19) United States
(12) Patent Application Publication
(10) Pub. No.: US 2006/0184523 A1
(43) Pub. Date: Aug. 17, 2006

(54) Search methods and associated systems

(75) Inventors: Larry Israel, Bellevue, WA (US); John Solaro, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/059,014

(22) Filed: Feb. 15, 2005

(51) Int. Cl. G06F 17/30

(52) U.S. Cl. 707/6; 707/1

(57) ABSTRACT

Search methods and associated systems are disclosed. One aspect of the invention is directed toward search methods and associated systems. One aspect of the invention is directed toward a computer-implemented searching method that includes receiving an input having a format. The method further includes finding a pattern that matches the format of the input using a rule set. The method still further includes determining a subject of the input based on the pattern, finding a result record corresponding to the subject, and sending an output based on the result record. In certain embodiments, the method can further include determining at least one qualifier based on the pattern and finding a result record corresponding to the subject and the at least one qualifier. In still other embodiments, the method can further include determining a subject of the input based on the pattern and at least one synonym rule.

### TECHNICAL FIELD

The following disclosure relates generally to search methods and associated systems, including tools for answering specific fact-based questions.

### BACKGROUND

Computer systems can store a wealth of information, however, it can often be difficult to find or retrieve a specific fact or piece of information when desired. Many search engines allow a user to search for information by entering one or more keywords that may be of interest to the user. After a user submits a search request that contains the keywords, the search engine identifies documents or web pages that may be related to those search terms. Often, the search engine returns a large number of documents or web page addresses, many of which have little or nothing to do with the specific piece of information that the user was seeking. The user is then left to sort through the list of documents, links, and associated information to find the desired fact. This process can be cumbersome, frustrating, and time consuming, especially when the user is looking for a single specific fact or fact set instead of general information about a topic.

### SUMMARY

The present invention is directed generally toward search methods and associated systems. One aspect of the invention is directed toward a computer-implemented searching method that includes receiving an input having a format (e.g., receiving a question). The method further includes finding a pattern that matches the format of the input using a rule set (e.g., a rule set that includes one or more context free grammar rules). The method still further includes determining a subject of the input based on the pattern, finding a result record corresponding to the subject, and sending an output based on the result record. In certain embodiments, this process can provide a user with an effective and efficient way to quickly search for information (e.g., to answer a question) in a computing system environment.

In certain embodiments, the method can further include determining at least one qualifier based on the pattern and finding a result record corresponding to the subject and the at least one qualifier. In other embodiments, the method can further include finding multiple result records corresponding to the subject. The result records can include a relevancy element, and the method can further include sending an output based on a portion of the multiple result records and the relevancy elements. In still other embodiments, the method can further include determining a subject of the input based on the pattern and at least one synonym rule.

Another aspect of the invention is directed generally toward a computer-implemented searching method that includes receiving an input having a format and finding a pattern that matches the format of the input using a rule set. The method can further include determining if the pattern is suitable for use with a fact tool or at least one other tool. If the pattern is suitable for use with the fact tool, the method can still further include determining a subject of the input based on the pattern, finding a result record corresponding to the subject, and sending an output based on the result record. In certain embodiments, if the pattern is suitable for use with the fact tool, the method can further include determining at least one qualifier using the rule set and finding a result record corresponding to the subject and the at least one qualifier.

### BRIEF DESCRIPTION OF THE DRAWINGS

FIG. 1 is a partially schematic illustration of a computing system suitable for implementing embodiments of the invention.

FIG. 2 is a flow diagram illustrating a computer-implemented searching method in accordance with embodiments of the invention.

FIG. 3 is a partially schematic illustration of a display having an input prompt, help information, and an input suitable for use in a computer-implemented searching process in accordance with certain embodiments of the invention.

FIG. 4 is a partially schematic illustration of at least a portion of a rule set suitable for use in a computer-implemented searching process in accordance with embodiments of the invention.

FIG. 5 is a partially schematic illustration of at least a portion of a result records table having at least one result record suitable for use in a computer-implemented searching process in accordance with certain embodiments of the invention.

FIG. 6 is a partially schematic illustration of at least a portion of a synonym table suitable for use in a computer-implemented searching process in accordance with embodiments of the invention.

FIG. 7 is a partially schematic illustration of at least a portion of another result records table having at least one result record suitable for use in a computer-implemented searching process in accordance with various embodiments of the invention.

FIG. 8 is a partially schematic illustration of an output in accordance with certain embodiments of the invention.

FIG. 9 is a flow diagram illustrating a computer-implemented searching method in accordance with other embodiments of the invention.

FIG. 10 is a flow diagram illustrating a computer-implemented searching method in accordance with still other embodiments of the invention.

### DETAILED DESCRIPTION

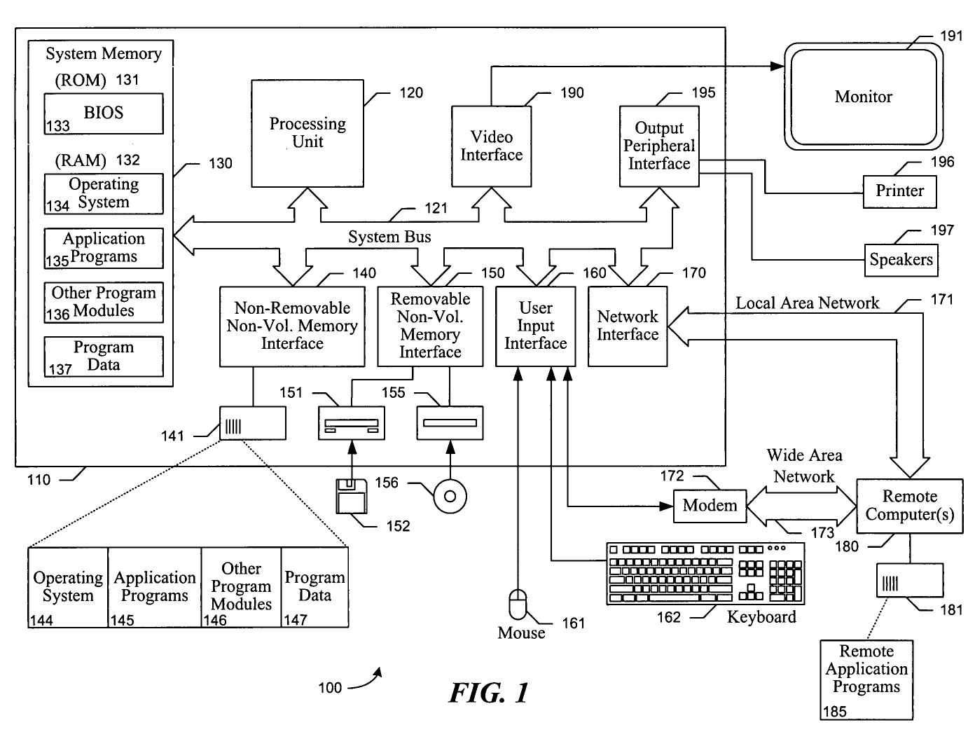

The following disclosure describes several embodiments of search methods and associated systems, including tools for answering specific fact-based questions. Specific details of several embodiments of the invention are described below to provide a thorough understanding of such embodiments. However, other details describing well-known structures and routines often associated with computer-based systems and computer-based searching methods are not set forth below to avoid unnecessarily obscuring the description of the various embodiments. Additionally, several flow diagrams and processes having process portions are described to illustrate various embodiments of the invention. It will be recognized, however, that these process portions can be performed in any order, and are not limited to the order described herein with reference to particular embodiments. Furthermore, those of ordinary skill in the art will understand that the invention may have other embodiments that include additional elements or lack one or more of the elements described below with reference to FIGS. 1-10.

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structure, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. It will be recognized that computer-readable media can store computer-executable instructions for performing at least a part of any or all process portions described herein.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements with computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port, or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

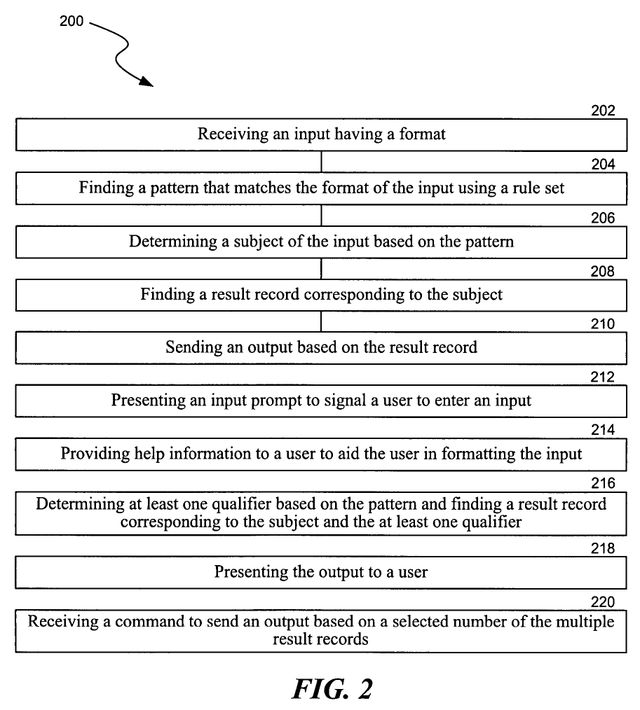

FIG. 2 is a flow diagram illustrating computer-implemented searching process 200 in accordance with embodiments of the invention. The process 200 includes receiving an input having a format (process portion 202) and finding a pattern that matches the format of the input using a rule set (process portion 204). The process 200 further includes determining a subject of the input based on the pattern (process portion 206) and finding a result record corresponding to the subject (process portion 208). The process 200 still further includes sending an output based on the result record (process portion 210). In certain cases, the process 200 can allow a user to quickly, effectively, and efficiently find a specific fact stored in a computing system environment. For example, in certain embodiments the process 200 can include a computer based fact tool that receives an input that includes a query or question, finds a pattern matching the format of the question, determines a subject of the question based on the pattern, finds a result record corresponding to the subject, and sends an output that includes an answer to the question.

In further embodiments, the process 200 can also include presenting an input prompt to signal a user to enter an input (process portion 212). In certain embodiments, the process 200 can further include providing help information to a user to aid the user in formatting the input (process portion 214). In other embodiments, the process 200 can also include determining at least one qualifier based on the pattern, and finding a result record corresponding to the subject can include finding a result record corresponding to the subject and the at least one qualifier (process portion 216). In still other embodiments, the process 200 can further include presenting the output to a user (process portion 218). In certain embodiments, finding a result record corresponding to the subject can include finding multiple result records corresponding to the subject and the process 200 can further include receiving a command to send an output based on a selected number of the multiple result records (process portion 220). In still other embodiments, the subject or the subject and qualifier(s) can be determined simultaneously with finding a pattern that matches the format.

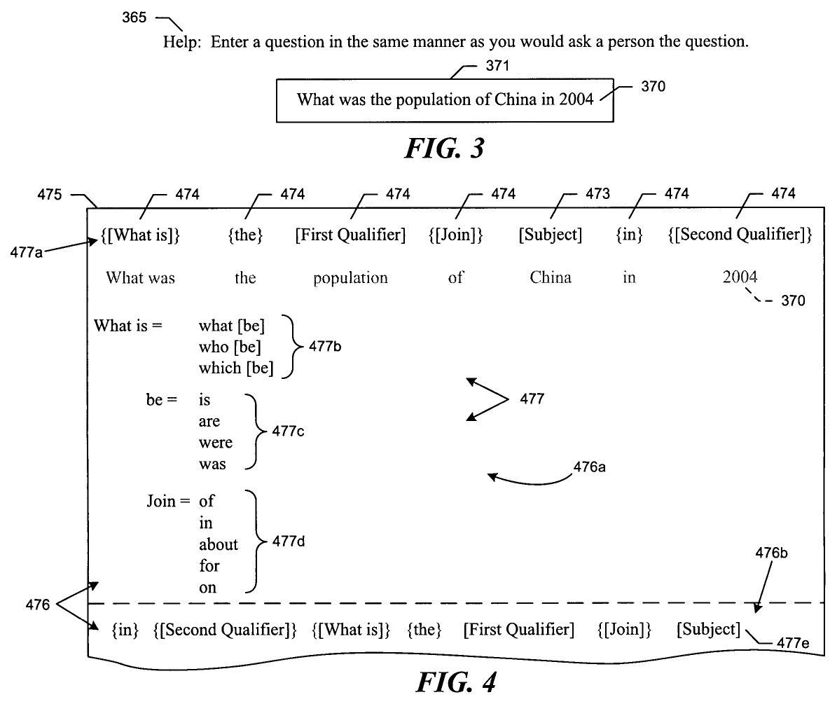

In the illustrated embodiment, receiving an input (process portion 202) can include receiving an input from a user through an input device (e.g., through a keyboard, mouse, and/or a microphone). In other embodiments, receiving an input (process portion 202) can including receiving an input from another source, for example, another computer application or process. As discussed above, in certain embodiments the process 200 can include presenting an input prompt to signal a user to enter an input (process portion 212) and/or providing help information to the user to aid the user in formatting the input (process portion 214). FIG. 3 illustrates a portion of a computer display having an input prompt 371, help information 365, and an input 370.

In FIG. 3, the input prompt 371 includes a text input box that signals a user to enter an input. In other embodiments, the input prompt 371 can include other arrangements. For example, in certain embodiments the input prompt 371 can include a text message and/or an audio message.

In the illustrated embodiment, help information 365 is displayed above the input prompt 371 and includes the text, “Help: Enter a question in the same manner as you would ask a person the question.” In other embodiments, the help information can be provided via other methods, for example, in audio form. In certain embodiments, help information is continually displayed. In other embodiments, help information is only displayed in response to certain conditions (e.g., when requested by the user, when the user makes an invalid input, and/or when the process 200 cannot be completed using the input 370). In certain embodiments, the help information 365 includes a link (e.g., a link to a help utility program or process). In other embodiments, the help information 365 includes an interactive process. For example, in certain embodiments, the user can search a table of contents or index for help information. In other embodiments, the help utility leads the user through a series of questions to aid the user in performing certain tasks (e.g., formatting the input 370).

In the illustrated embodiment, the user has entered an input 370 via a keyboard that includes the text, “What was the population of China in 2004.” In other embodiments, the user can enter an input 370 via other methods (e.g., using an audio or voice input). The input 370 can include one or more portions. As discussed below in further detail, the input 370 can be parsed into multiple portions via the process 200 discussed above with reference to FIG. 2. For example, in certain embodiments the input 370 can include a first portion that corresponds to the subject of the input (e.g., the subject as determined by the searching process 200) and one or more second portions. Each portion of the input can include various items, including one or more word(s), letter(s), number(s), reference(s) and/or symbol(s).

Additionally, an input 370 can be formatted in various manners. For example, while the input 370 in the illustrated embodiment includes the phrase “What was the population of China in 2004,” the user could have entered an input that included the phrase “in 2004 what was the population of China.” Although these two phrases have similar meanings, they have different grammar structures and different formats (e.g., word order).

FIG. 4 is a partially schematic illustration of a portion of a rule set 475 used in a computer-implemented searching process in accordance with certain embodiments of the invention. For example, the rule set can include rules that govern or define the computer-implemented searching process (e.g., the rule set can include context free grammar used to parse the input). The rule set 475 can include a single rule 477, multiple rules 477, and/or one or more rule subsets 476. In certain embodiments, the rule set 475 can be stored in one or more computer accessible files and accessed one or more times during the searching process. In the illustrated embodiment, the rule set 475 includes two rule subsets 476, shown as a first rule subsets 476a and a second rule subset 476b. The first rule subset 476b includes four rules 477, shown as a first rule 477a, a second rule 477b, a third rule 477c, and a fourth rule 477d. The second rule subset 476b includes at least one rule 477, shown as a fifth rule 477e.

In the illustrated embodiment, the first and fifth rules 477a and 477e include patterns that can be compared to the input 370 (shown in ghosted characters) to find a pattern that matches the format of the input (process portion 204 discussed above with reference to FIG. 2). In certain embodiments, the patterns can include multiple portions. Similar to the input portion(s) discussed above, portion(s) of the patterns can include various items including one or more word(s), letter(s), number(s), reference(s), and/or symbol(s). For example, the first rule 477a includes a first portion 473, and six second portions 474. In other embodiments, the first rule 477a can have more or fewer portions.

In certain embodiments, selected portions of the patterns in the rules 477 can be optional. In order for a specific pattern to match the format of the input 370, the input 370 can, but does not have to contain portions that match the optional portions of the specific pattern. In FIG. 4, optional portions are enclosed in braces (e.g., { }).

Additionally, in certain embodiments, selected portions of the pattern can include variable terms. In certain cases, the variable terms are limited to a selected number of specified items (e.g., specific word(s), letter(s), number(s), reference(s), and/or symbol(s)). In other cases, the variable terms can include any item. In FIG. 4, variable terms are enclosed in brackets (e.g., [ ]). In the illustrated embodiment, the second rule 477b, third rule 477c, and fourth rule 477d define corresponding variable terms in the first rule 477a (e.g., define a list of items that the corresponding variable terms can be). In certain embodiments, these variable definitions can be used by other rules (e.g., the fifth rule 477e). In other embodiments, these variable definitions can be stored in other locations, for example, they can be stored in a separate subset of rules, a separate table, or a separate file. In still other embodiments, various patterns (e.g., rules 477) can have a dedicated set of variable term definitions.

In the illustrated embodiment, the format of the input 370 matches the pattern of the first rule 477a. The {[whatis]} portion of the pattern corresponds to the “what was” portion of the input 370, the {the} portion of the pattern corresponds to the “the” portion of the input 370, the {[join]} portion of the pattern corresponds to the “of” portion of the input 370, and the {in} portion of the pattern corresponds to the “in” portion of the input 370. The input 370 also includes portions that are located or positioned in the input 370 to correspond with the [first qualifier], the [subject], and the {[second qualifier]} portions of the pattern. Accordingly, the pattern of the first rule 477a matches the input 370. In certain embodiments, the input 370 can match more than one pattern or rule 477. For example, in certain embodiments, the input 370 can be parsed differently when being matched to a different pattern (e.g., the input 370 can be divided into different portions or word groups to fit a different pattern). In some embodiments, the rules 477 can include additional features. For example, in certain embodiments, a pattern will be found to match the format of the input 370 only when the pattern matches the format and the portion of the input corresponding to the subject contains a certain item or group of items.

Because the pattern of the first rule 477a matches the input 370, a subject of the input 370 can be determined based on the pattern (process portion 206 discussed above with reference to FIG. 2). In the illustrated embodiment, the “China” portion of the input 370 corresponds to the [subject] portion of the pattern. Accordingly, in the illustrated embodiment “China” can be identified as the subject of the input 370 based on the pattern, and can be used in the searching process to find a result record (process portion 208 discussed above with reference to FIG. 2). In some cases, the subject identified by process portion 206 is the grammatical subject of the input 370 (e.g., the grammatical subject of a question). In other cases, the subject identified by process portion 206 is different from the grammatical subject of the input and/or the input does not have a grammatical subject. In other embodiments, additional rules 477 can be used with the patterns to determine the subject of the input 370. For example, as discussed below in further detail, in certain embodiments once a portion of the input 370 corresponding to the subject is identified, a synonym table can be used to identify a synonym for the portion of the input 370 and the synonym can be identified as the subject of the input 370 (e.g., the subject of the input 370 can be a word or word group that is not actually contained in the input 370).

Multiple inputs 370 can match the pattern of the first rule 477a. For example, an input, “what is the population of China,” does not include the {in} and {[second qualifier]} portions of the first rule 477a and the input portion corresponding to the {[whatis]} portion is “what is” instead of “what was,” but the input “what is a population of China” matches the first rule 477a, with the “China” portion corresponding to the subject. Similarly, inputs that include “population of China,” and “population China” also match the pattern of the first rule 477a, with “China” corresponding to the subject. An input “what is the population of China Tex.” (e.g., what is the population of the city China in the state of Texas) also matches the pattern of the first rule 477a, with “China Tex.” corresponding to the subject and “population” corresponding to the first qualifier. Additionally, “what is the population of the People's Republic of China,” matches the pattern of the first rule 477a, with “the People's Republic of China” corresponding to the subject. Similarly, “what is the population of the PRC” matches the pattern of the first rule 477a, with “the PRC” corresponding to the subject. “China population” also matches the pattern of the first rule 477a, but with “population” corresponding to the subject and “China” corresponding to the first qualifier.

The input, “in 2004 what was the population of China” does not match the pattern of the first rule 477a, but does match the pattern of the fifth rule 477e. Using the fifth rule, “China” corresponds to the subject, “population” corresponds to the first qualifier, and “2004” corresponds to the second qualifier. Accordingly, although using different rules (e.g., the fifth rule 477e and the first rule 477a), the same subject and qualifier can be determined for the input “in 2004 what was the population of China” and the input “what was the population of China in 2004.” As discussed below in further detail, in certain embodiments this feature can allow the same result record to be found for both inputs.

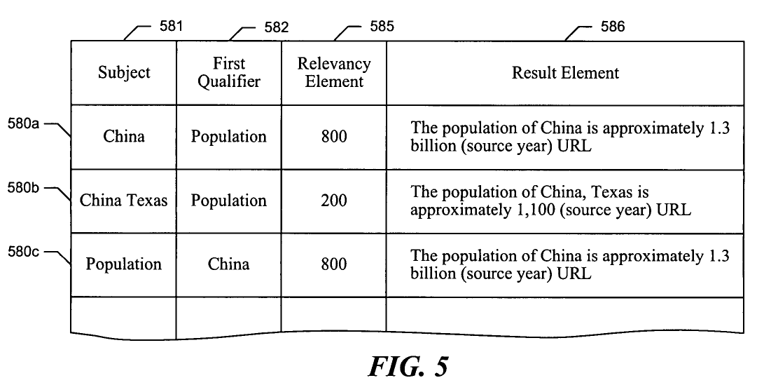

Once a subject is determined, a result record corresponding to the subject can be found (process portion 208 discussed above with reference to FIG. 2). In certain embodiments where one or more qualifiers are identified, a result record corresponding to the subject and at least one qualifier can be found (process portion to 216 discussed above with reference to FIG. 2). FIG. 5 illustrates at least a portion of a table having at least one result record suitable for use in the searching process. In FIG. 5, three result records are shown, as a first result record 580a, a second result record 580b, and a third result record 580c. The result records can include one more elements, including a subject 581, a first qualifier 582, a relevancy element 585, and a result element 586.

In other embodiments, a result records table can have more or fewer result records and/or the result records can have more, fewer, and/or different elements. For example, in certain embodiments a result records table can include links or references to other tables or data files. In other embodiments, the result records can be part of the rule set discussed above with reference to FIG. 4. In certain embodiments, there can be a separate set of result records associated with each pattern contained in the rule set. In other embodiments, one or more sets of result records can be associated with multiple patterns or rules, allowing the same result record corresponding to a specific subject to be found for two different inputs that each have the specific subject, even though different rules were used to determine the subject of each input.

Once the subject or a subject and at least one qualifier (e.g., a subject/qualifier(s) combination) have been identified, the result records table can be searched to find one or more corresponding result records. For example, in the illustrated embodiment a subject “China” and a qualifier “population” can correspond to the first result record 580a. An output can be sent (e.g., to a user or to another application) based on the result element 586 of the first resort record 580a. For example, an output containing “The population of China is approximately 1.3 billion (source year) URL” can be sent to a user in response to an input that included “what is the population of China.” The “source year” can include the source (e.g., the name of an encyclopedia) on which the result element 586 is based and the date or year of that source. The “URL” can include one or more links to other tables, files, and/or sources (e.g., to a website) containing additional information that might be of interest to the user.

In certain cases, it can be desirable to return multiple results to a single query. For example, an input that includes “what is the population of China” can be a query about the population of the country China or the population of the city China in the state of Texas. Accordingly, the result records can contain references, pointers, and/or links to other records or tables. For example, in the illustrated embodiment, a subject of “China” and a qualifier of “population” can correspond to a first result record 580a. The first result record 580a can include a reference to the second result record 580b. The output, can be based on both the first result record 580a and the second result record 580b. For example, the output can include “the population of China is approximately 1.3 billion (source year) URL; the population of China, Tex. is approximately 1,100 (source year) URL.” This feature can provide a user with an unambiguous answer to the user's query, even when there are ambiguities with respect to the user's query.

In other embodiments, input ambiguities can be handled using various methods and/or rules regarding finding a result record corresponding to a subject or subject/qualifier(s) combination. As illustrated above, in certain embodiments a result record corresponds to a subject or a subject/qualifier(s) combination only when all the identified subjects and qualifiers are contained in the result record. In other embodiments, a result record corresponds to a subject or subject/qualifier(s) combination when the subject and/or the subject and a selected number of qualifiers are contained in the result record. For example, in certain embodiments, the search process can be set up such that a result record is found to correspond to a subject or subject/qualifier(s) combination when the subject or the subject and first qualifier are contained in the result record, regardless of whether there are any other qualifiers. Accordingly, an output can be sent or returned based on some or all of the corresponding result records. In still other embodiments, the number of qualifiers that must be matched to find a corresponding result record can be fixed or vary with different factors (e.g., the pattern used to determine the subject and/or the number of qualifiers identified by the pattern).

Additionally, as shown in FIG. 5, a result records table can contain result records that correspond to different subjects and/or subject/qualifier(s) combinations. For example, in FIG. 5 an input having a subject of “population” and a qualifier of “China” will match the third input record 580c. Because an input with a subject of “population” and a qualifier of “China” is similar to an input with a subject of “China” and a qualifier of “population,” the result element 586 for the third result record 580c can be similar to that of the first result record 580a.

In certain embodiments, the relevancy element 586 can be used to determine the order the result records will be used in the output and/or whether certain result records will be used at all. For example, in the illustrated embodiment the first resort record 580a has a larger relevancy element 586 (e.g., 800) than that of the second result record 580b (e.g., 200). Accordingly, the first result record 580a was used first in the output discussed above.

In certain embodiments, the relevancy element 586 can include fixed values and/or smaller relevancy elements 586 can take priority over larger relevancy elements 586. In other embodiments, the relevancy elements 586 can have other arrangements. In certain embodiments, the relevancy elements 586 can include other items or values (e.g., a numeric or alphanumeric value or term can be used to order the use of the relevancy records 586). In other embodiments, the relevancy elements 586 can be computed based on the pattern used to determine the subject of the input. For example, in certain embodiments the result records 580 can have different values for the relevancy elements 586 depending on whether the pattern in the first rule 477a or the fifth rule 477e, discussed above with reference to FIG. 4, was used to determine the subject of the input. In other embodiments, the number of optional qualifiers identified based on the pattern and/or the actual qualifier(s) identified (e.g., the actual item, value, or content that is identified as the qualifier(s)) can be used to determine the relevancy elements 586 of the associated result records 580. In certain embodiments, the process can include sending multiple outputs based on multiple result records 580 and the relevancy elements 586 can be used to determine the order in which the result records 580 are used and/or whether certain results records 580 are used at all to generate the multiple inputs. In still other embodiments, relevancy records are not used to establish a priority for the result records.

As discussed above, different inputs can include different terms or items that have similar meanings (e.g., synonyms). For example, a user who enters an input that includes “what is the population of China,” may be requesting the same information as another user who enters “what is the population of the PRC.” Accordingly, it can be desirable to account for synonyms when determining the subject of an input and/or when finding a result record.

In certain embodiments, the result records table can include synonyms for the subject(s) and/or qualifier(s). For example, if the subject of the input is “the People's Republic of China” or “the PRC,” the result records table can include a result record with the subject of “the People's Republic of China” and another result record with the subject of “the PRC.” Both result records can have result elements 586 similar to that of the first result record 580a that has “China” as a subject. In other embodiments, the subject of the first result record 580a can include “‘China’ or ‘the PRC’ or ‘the People's Republic of China’” and the result record can correspond to a subject that includes any of the three terms.

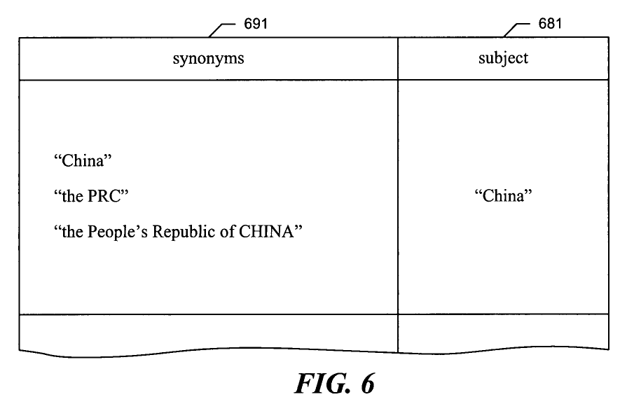

In still other embodiments, synonyms can be identified using a separate rule, separate table, separate database, or separate part of the result records table. For example, in certain embodiments determining the subject or subject/qualifier(s) combination of the input based on the pattern can include determining a subject of the input based on the pattern and the rules set (e.g., where the rule set includes one or more synonym rules, tables, and or data). As shown in FIG. 6, a synonym table or rule can include one or more synonyms 691 and one or more subjects 681. In the illustrated embodiment, three synonyms 691 are shown. The three synonyms 691 include “China,” “the PRC,” and “the People's Republic of China” and all are associated with the subject 681 “China.” Accordingly, given an input that includes “what is the population of the PRC,” a rule or pattern can be used to determine that “the PRC” portion of the input corresponds to the subject of the input. The synonym table shown in FIG. 6 can then be used to determine that “China” is the subject of the input, even though “China” does not actually appear in the input. “China” can then be used to find a corresponding result record or records.

In certain embodiments where there are multiple result records associated with a subject and/or a subject/qualifier(s) combination, it can also be desirable to base an output on a selected number of result records. For example, in some embodiments a user can select a number of result records on which the output will be based. In other embodiments, a process may base the output on a selected number of result records and/or only use result records having a selected range of relevancy elements. Although, this feature can be applied to many or all of the embodiments described herein, it can be especially useful for inputs that are associated with finding the largest or smallest of items in a set.

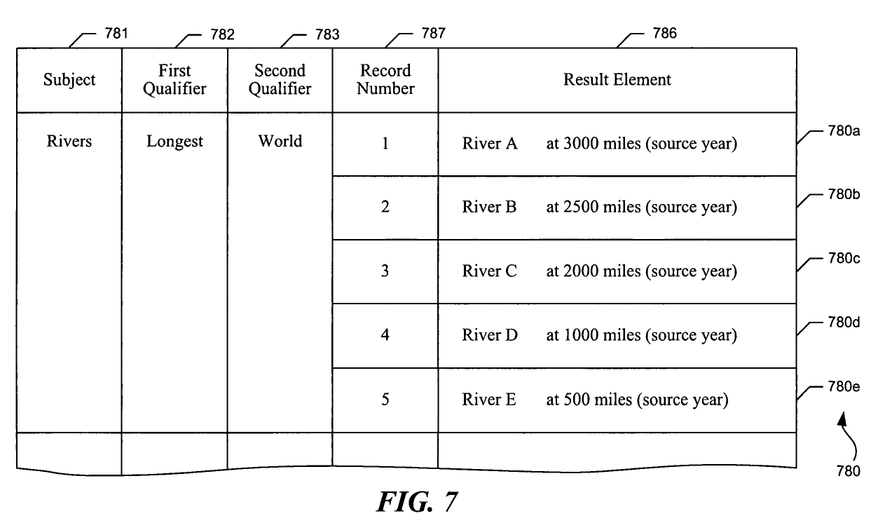

For example, in certain embodiments an input can include a query that asks, “What are the three longest rivers in the world?” The input can match a pattern (e.g., a rule) and the pattern can be used to determine that a subject of the input is “rivers,” a first qualifier of the input is “longest,” and a second qualifier of the input is “world.” Additionally, a third qualifier and/or a command “three” can be identified and used to indicate the number of result records upon which the output should be based. In the illustrated embodiment, the pattern used to determine the subject and the qualifiers can be associated with one or more specific result records tables that contain result records corresponding to one or more lists of largest and/or smallest items. FIG. 7 shows a portion of a result records table having a selected number of the longest rivers in the world. In other embodiments, the actual items in the subject and/or one or more of the qualifiers can be used with the pattern to determine the associated result records table(s) to be used.

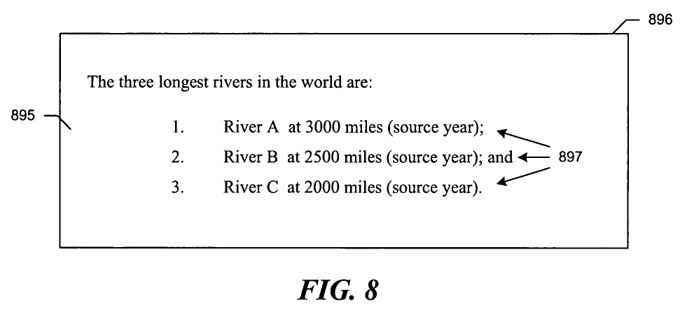

The result records table in FIG. 7 includes a subject 781 (e.g., rivers), a first qualifier (e.g., longest) 782, and a second qualifier (e.g., world) 783 as a common entry for all result records associated with the list of the worlds longest rivers. Additionally, the result records table in FIG. 7 contains one or more result records, shown as a first result record 780a, a second result record 780b, a third result record 780c, a fourth result record 780d, and a fifth result record 780e. The result records 780 can be arranged in a selected order (e.g., smallest to largest or largest to smallest). In FIG. 7, the result records are ranged from largest to smallest and are associated with record numbers 787. Because the input includes a third qualifier and/or a command “three,” the output (shown below in FIG. 8) can be based on a portion of the result records (e.g., the first, second, and third result records 780a, 780b, and 780c) contained in the result records table.

In FIG. 8, the display 896 includes an output 895 that has three portions 897 that correspond to the reference numbers 787 and result elements 786 of the first, second, and third result records 780a, 780b, and 780c shown in FIG. 7. In the illustrated embodiment, a rule (e.g., from the rule set) is used to provide other portions of the output. For example, the rule can supply “The three longest rivers in the world are:” portion of the output 895 (e.g., from a separate portion of the result records table). The reference numbers 787 and result elements 786 of the first, second, and third result records 780a, 780b, and 780c (shown in FIG. 7) are then inserted sequentially into the output 895 and separated by semicolons. The term “and” is added after the last semicolon and a period is inserted at the end of the output 895.

In other embodiments, the output can be derived by other processes and/or include other arrangements. For example, in certain embodiments portions of the input can be used to build an output string (e.g., the “the three longest rives in the world” portion and the “are” portion of the input “What are the three longest rivers in the world?” can be used to build the “three longest rivers in the world are” portion of the output 895). In still other embodiments, the output can be sent and/or presented in other forms. For example, in certain embodiments the output can be sent to another computer application. In other embodiments, instead of displaying the output to a user, the output can be presented to the user in an audio format.

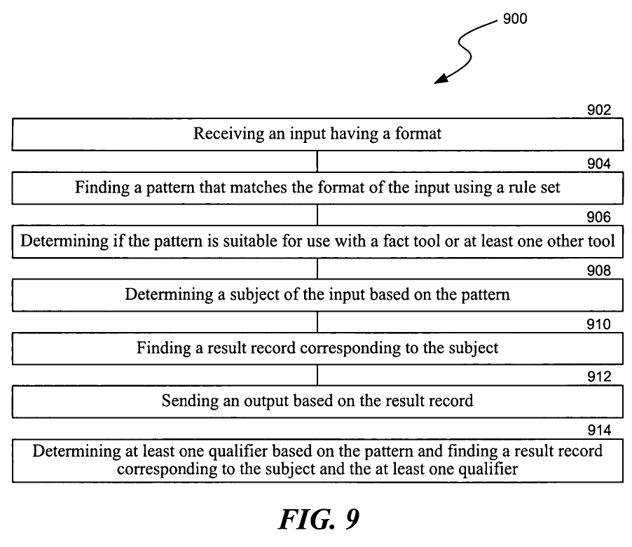

As shown in FIG. 9, embodiments described above (e.g., fact tools) can be combined with other applications or tools to provide increased utility. For example, other applications can include a dictionary tool, a calculator tool, an equation solving tool, and a conversion tool. Accordingly, a computer implemented process 900 can include receiving an input having a format (process portion 902) and finding a pattern that matches the format of the input using a rule set (process portion 904). The process 900 can further include determining if the pattern is suitable for use with a fact tool or at least one other tool (process portion 906). If the pattern is suitable for use with the fact tool, the process can further include determining a subject of the input based on the pattern (process portion 908), finding a result record corresponding to the subject (process portion 910), and sending an output based in the result record (process portion 912). In certain embodiments, the method can further include determining at least one qualifier based on the pattern, and finding a result record can include finding a result record corresponding to the subject and the at least one qualifier (process portion 914). In still other embodiments, the subject or the subject and qualifier(s) can be determined simultaneously with finding a pattern that matches the format.

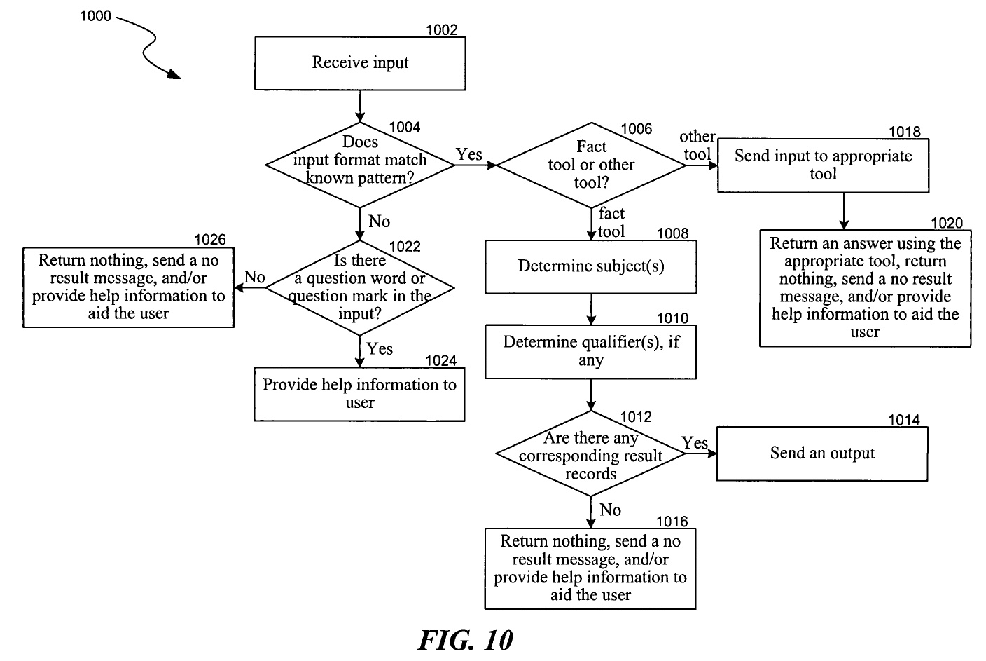

A feature of some of the embodiments described above is that a process (e.g., a fact tool) can provide a method through which a user can quickly, effectively, and efficiently find selected information. An advantage of this feature is that information can be found in less time and with less frustration than with current methods. For example, as shown in FIG. 10, a process 1000 can include receiving an input (process portion 1002) from a user or another computer application. The process 1000 can further include determining whether the input format matches one or more known patterns (process portion 1004). If the input includes a format that matches one or more known patterns, the method can further include determining whether the input (or a portion of the input) should be passed to a fact tool or another tool (process portion 1006).

If the input is suitable for use with the fact tool, the process 1000 can further include determining one or more subjects (process portion 1008); determining one or more qualifiers, if any (process portion 1010); and determining if there are one or more corresponding result records (process portion 1012). If there is at least one corresponding result record, the process 1000 can further include sending one or more outputs based on at least one of the one or more result records (process portion 1014). In certain embodiments, the output can be sent in an XML format to facilitate use in or with another computer application. If there are no corresponding result records, the process 1000 can include returning nothing, sending a no result message, and or providing help information to aid the user (process portion 1016). For example, in certain embodiments the process 1000 can provide help information to aid the user in formatting an input.

If the input format matches one or more known patterns (process portion 1004), but is not suitable for use by the fact tool (process portion 1006), the input (or portion of the input) can be sent to an appropriate tool (process portion 1018) and the process 1000 can return an answer using the appropriate tool, return nothing, send a no result message, and/or provide help information to aid the user (process portion 1020). If the input format does not match a known pattern (process portion 1004), the process 1000 can determine whether there is a question word (e.g., what, who, how, when, where, or why) or a question mark in the input (process portion 1022). If there is a question word or a question mark in the input, the process 1000 can provide help information to the user (process portion 1024). If there are no question words and/or question marks in the input, the process 1000 can return nothing, send a no result message, and or provide help information to aid the user (process portion 1026). Accordingly, the process 1000 can provide an efficient and effective method of quickly finding selected information in a computing environment.

From the foregoing, it will be appreciated that specific embodiments of the invention have been described herein for purposes of illustration, but that various modifications may be made without deviating from the invention. For example, aspects of the invention described in the context of particular embodiments may be combined or eliminated in other embodiments. Although advantages associated with certain embodiments of the invention have been described in the context of those embodiments, other embodiments may also exhibit such advantages. Additionally, none of the embodiments need necessarily exhibit such advantages to fall within the scope of the invention. Accordingly, the invention is not limited except as by the appended claims.

We claim:

1. A computer-implemented searching method, comprising:
receiving an input having a format;
finding a pattern that matches the format of the input using a rule set;
determining a subject of the input based on the pattern;
finding a result record corresponding to the subject; and
sending an output based on the result record.

2. The method of claim 1 wherein the subject corresponds to a first portion of the input, the input having at least one second portion different than the first portion.

3. The method of claim 1 wherein the rule set includes at least one of a single rule, multiple rules, a rule subset, and multiple rule subsets.

4. The method of claim 1 wherein the input has a first portion and one or more second portions different than the first portion, the subject being the first portion of the input, and wherein the method further comprises determining at least one qualifier based on the pattern, each qualifier being one of the second portions of the input, and wherein finding a result record corresponding to the subject includes finding a result record corresponding to the subject and the at least one qualifier.

5. The method of claim 1 wherein finding a result record corresponding to the subject includes finding multiple result records corresponding to the subject and sending an output includes sending an output based on at least a portion of the multiple result records.

6. The method of claim 1 wherein finding a result record corresponding to the subject includes finding multiple result records corresponding to the subject and wherein the method further comprises receiving a command to send an output based on a selected number of the multiple result records.

7. The method of claim 1 wherein finding a result record corresponding to the subject includes finding multiple result records corresponding to the subject, each result recording including a relevancy element, and wherein sending an output includes sending an output based on a portion of the multiple result records, the portion of multiple records being selected based on the relevancy element.

8. The method of claim 1 wherein finding a result record corresponding to the subject includes finding multiple result records corresponding to the subject, each result recording including a relevancy element, and wherein sending an output includes sending an output with multiple portions, each multiple portion based on one of the multiple result records, the order of the multiple portions in the output based on the relevancy element of the result records.

9. The method of claim 1 wherein the method further comprises at least one of:
presenting an input prompt to signal a user to enter an input; and
presenting the output to the user.

10. The method of claim 1 wherein determining a subject of the input based on a pattern includes determining a subject of the input based on a pattern and at least one synonym rule.

11. The method of claim 1 wherein the input is received from a user and wherein the method further comprises providing help information to the user to aid the user in formatting the input.

12. The method of claim 1 wherein:
finding a pattern that matches the format of the input includes finding multiple patterns that match the format of the input;
determining a subject of the input based on the pattern includes determining multiple subjects based on the multiple patterns;
finding a result record corresponding to the subject includes finding multiple result records corresponding to the multiple subjects; and
sending an output based on the result record includes sending an output based on one or more of the multiple result records.

13. A computer-implemented searching method, comprising:
receiving an input having a format;
finding a pattern that matches the format of the input using a rule set; and
determining if the pattern is suitable for use with a fact tool or at least one other tool, and if the pattern is suitable for use with the fact tool:
determining a subject of the input based on the pattern;
finding a result record corresponding to the subject; and
sending an output based on the result record.

14. The method of claim 13 wherein the input has a first portion and one or more second portions different than the first portion, the subject being the first portion of the input, and wherein if the pattern is suitable for use with the fact tool, the method further comprises determining at least one qualifier based on the pattern, each qualifier being one of the second portions of the input, and wherein finding a result record corresponding to the subject includes finding a result record corresponding to the subject and the at least one qualifier.

15. A computer-readable medium having computer-executable instructions for performing steps comprising:
receiving an input having a format;
finding a pattern that matches the format of the input using a rule set;
determining a subject of the input based on the pattern;
finding a result record corresponding to the subject; and
sending an output based on the result record.

16. The computer-readable medium of claim 15 wherein the input has a first portion and one or more second portions different than the first portion, the subject being the first portion of the input, and wherein the steps further comprise determining at least one qualifier based on the pattern, each qualifier being one of the second portions of the input, and wherein finding a result record corresponding to the subject includes finding a result record corresponding to the subject and the at least one qualifier.

17. The computer-readable medium of claim 15 wherein finding a result record corresponding to the subject includes finding multiple result records corresponding to the subject and wherein the steps further comprise receiving a command to send an output based on a selected number of the multiple result records.

18. The computer-readable medium of claim 15 wherein the steps further comprise at least one of:
presenting an input prompt to signal a user to enter an input; and
presenting the output to the user.

19. The computer-readable medium of claim 15 wherein the step of determining a subject of the input based on a pattern includes determining a subject of the input based on a pattern and at least one synonym rule.

20. The computer-readable medium of claim 15 wherein the input is received from a user and wherein the steps further comprise providing help information to the user to aid the user in formatting the input.
